(19) United States
(12) Patent Application Publication
(10) Pub. No.: US 2026/0044931 A1
(43) Pub. Date: Feb. 12, 2026

(54) SUPER RESOLUTION SYSTEM TRAINED BASED ON OBFUSCATED LOW-RESOLUTION DATA

(71) Applicant: GM Global Technology Operations LLC, Detroit, MI (US)

(72) Inventors: Fahim Ahmed, Troy, MI (US); Kamran Ali, Troy, MI (US); Donald K. Grimm, Utica, MI (US)

(21) Appl. No.: 18/796,989

(22) Filed: Aug. 7, 2024

(51) Int. Cl. G06T 3/4053; G06T 3/4046

(52) U.S. Cl. CPC G06T 3/4053; G06T 3/4046

(57) ABSTRACT

A super resolution system that increases a resolution of image data captured by one or more cameras include one or more controllers including one or more super resolution neural networks that include at least one of an obfuscated image data model and a focused loss model. The one or more super resolution neural networks receive paired training data during a training phase, where the paired training data is representative of the image data captured by the one or more cameras representing a surrounding environment and includes low-resolution image data and high-resolution image data. The obfuscated low-resolution image data and the high-resolution image data both represent identical images, and the obfuscated low-resolution image data includes an object of interest located in the surrounding environment that is obfuscated based on an obfuscation technique.

### INRTODUCTION

The present disclosure relates to a super resolution system for increasing the resolution of image data captured by one or more cameras. The super resolution model includes one or more super resolution neural networks that are trained based on paired training data including obfuscated low-resolution image data and high-resolution image data.

A vehicle may utilize various types of perception sensors for gathering perception-related data regarding the surrounding environment. One particular type of perception sensor that is commonly employed by a vehicle is a camera, which collects image data regarding the surrounding environment. The image data representing the surrounding environment may be used in a variety of vehicular systems and applications such as, for example, crowdsourced mapping. Crowdsource mapping involves collecting perception data from numerous connected vehicles, where the perception data is used to generate and update maps.

It is to be appreciated that the image data collected by many cameras in vehicles tend to have a relatively low resolution as well as limited color information. The lower resolution image data may create challenges when an object detection system attempts to detect and interpret certain types of objects, such as traffic signs. This issue may be further exacerbated in situations where the traffic sign is located at longer distances or is obfuscated. For example, a traffic sign may be obfuscated by vegetation growth, weather conditions such as rain and fog, graffiti, or by objects in the vicinity of the traffic sign such as poles and surrounding vehicles. If the object detection system is employed for crowdsourced mapping, then the camera may oversample some geographical areas to ensure sufficient image data is available to provide accurate traffic sign feature extraction. However, oversampling data requires longer data campaigns and greater communications bandwidth.

There are super resolution imaging techniques that currently exist for enhancing or increasing the resolution and/or the frame rate of image data. However, existing super resolution techniques may not be able to provide the improvement in resolution that is required for some applications such as crowdsourced mapping. Furthermore, existing super resolution imaging techniques are unable to compensate for objects in the environment that are occluded.

Thus, while current object detection systems achieve their intended purpose, there is a need in the art for an improved approach for enhancing the resolution of image data captured by a camera.

### SUMMARY

According to several aspects, a system for a super resolution system that increases the resolution of image data captured by one or more cameras is disclosed. The super resolution system includes one or more controllers including one or more super resolution neural networks that include an obfuscated image data model. The one or more controllers include one or more processors that execute instructions to receive, by the obfuscated image data model, paired training data during a training phase, where the paired training data is representative of the image data captured by the one or more cameras representing a surrounding environment and includes obfuscated low-resolution image data and high-resolution image data. The obfuscated low-resolution image data and the high-resolution image data both represent identical images, and the obfuscated low-resolution image data includes an object of interest located in the surrounding environment that is obfuscated based on an obfuscation technique. The one or more controllers increase, by the obfuscated image data model, a resolution of the obfuscated low-resolution image data to create a reconstructed high-resolution image. The one or more controllers calculate, by the obfuscated image data model, a total loss associated with the reconstructed high-resolution image, wherein the high-resolution image data of the paired training data acts as ground truth data and the obfuscated image data model is trained based on an iterative process to minimize the total loss. The one or more controllers receive, by the obfuscated image data model, real-life low-resolution image data a testing phase. The one or more controllers increase, by the obfuscated image data model, the resolution of the real-life low-resolution image data to create real-life high-resolution image data.

In another aspect, the total loss associated with the reconstructed high-resolution image is a sum of a mean squared error loss, a perceptual loss, an adversarial loss, and a total variance loss.

In yet another aspect, the one or more super resolution neural networks includes a focused loss model.

In an aspect, the one or more controllers execute instructions to receive, by the focused loss model, the paired training data during the training phase, increase, by the focused loss model, a resolution of the obfuscated low-resolution image data to create a focused reconstructed high-resolution image, calculate, by the focused loss model, a focused loss associated with the focused reconstructed high-resolution image, wherein the high-resolution image data of the paired training data acts as ground truth data and the focused loss is a sum of a focused mean squared error loss, a focused perceptual loss, and a focused total variance loss, receive, by the focused loss model, real-life low-resolution image data a testing phase, and increase, by the focused loss model, the resolution of the real-life low-resolution image data to create real-life high-resolution image data.

In another aspect, the one or more controllers execute instructions to determine a bounding box defining a bounded area within an image frame of the obfuscated low-resolution image data, where the bounding box contains the object of interest.

In yet another aspect, the focused loss associated with the focused reconstructed high-resolution image assigns a higher value to a bounded weighting factor corresponding to the bounded area of the image frame when compared to a whole weighting factor corresponding to the entirety of the image frame.

In an aspect, the one or more controllers determine the focused mean squared error loss by determining a mean squared error loss associated with the bounded area of the image frame, and determining a mean squared error loss associated with the entirety of the image frame, where the focused mean squared error loss is the sum of a weighted mean squared error loss associated with the bounded area within the image frame and a weighted mean squared error loss associated with the entirety of the image frame.

In another aspect, the one or more controllers determine the focused perceptual loss by determining a focused perceptual loss associated with the bounded area of the image frame, and determining a focused perceptual loss associated with the entirety of the image frame, where the focused perceptual loss is the sum of a weighted perceptual loss associated with the bounded area within the image frame and a weighted perceptual loss associated with the entirety of the image frame.

In yet another aspect, the one or more controllers determine the focused total variance loss by determining a focused total variance loss associated with the bounded area of the image frame and determining a focused total variance loss associated with the entirety of the image frame. The focused total variance loss is the sum of a weighted focused total variance loss associated with the bounded area within the image frame and a weighted focused total variance loss associated with the entirety of the image frame.

In an aspect, the focused mean squared error loss, the focused perceptual loss, and the focused total variance loss each include different values for the bounded weighting factor and whole weighting factor.

In another aspect, the object of interest is one of the following: a traffic sign, a pedestrian, a bicyclist, an animal, a street sign, a billboard, a commercial sign, a surrounding vehicle, and an infrastructure asset.

In yet another aspect, the obfuscated low-resolution image data includes a resolution that is less than or equal to 480 x 640 pixels, and the high-resolution image data includes a resolution that is greater than 480 x 640 pixels.

In an aspect, the obfuscation technique includes one of the following: deleting a portion of object of interest, randomly removing pixels that represent the object of interest, blurring the object of interest, and darkening image data associated with the object of interest.

In another aspect, a super resolution system that increases the resolution of image data captured by one or more cameras is disclosed. The super resolution system includes one or more controllers including one or more super resolution neural networks that include a focused loss model. The one or more controllers include one or more processors that execute instructions to receive, by the focused loss model, paired training data during a training phase, where the paired training data is representative of the image data captured by the one or more cameras representing a surrounding environment and includes obfuscated low-resolution image data and high-resolution image data. The obfuscated low-resolution image data and the high-resolution image data both represent identical images, and the obfuscated low-resolution image data includes an object of interest located in the surrounding environment that is obfuscated based on an obfuscation technique. The one or more controllers increase, by the focused loss model, a resolution of the obfuscated low-resolution image data to create a focused reconstructed high-resolution image. The one or more controllers calculate, by the focused loss model, a focused loss associated with the focused reconstructed high-resolution image. The high-resolution image data of the paired training data acts as ground truth data and the focused loss is a sum of a focused mean squared error loss, a focused perceptual loss, and a focused total variance loss. The one or more controllers receive, by the obfuscated image data model, real-life low-resolution image data a testing phase. The one or more controllers increase, by the obfuscated image data model, the resolution of the real-life low-resolution image data to create real-life high-resolution image data.

In another aspect, the one or more controllers execute instructions to determine a bounding box defining a bounded area within an image frame of the obfuscated low-resolution image data, where the bounding box contains the object of interest.

In yet another aspect, the focused loss associated with the focused reconstructed high-resolution image assigns a higher value to a bounded weighting factor corresponding to the bounded area of the image frame when compared to a whole weighting factor corresponding to the entirety of the image frame.

In an aspect, the one or more controllers determine the focused mean squared error loss by determining a mean squared error loss associated with the bounded area of the image frame, and determining a mean squared error loss associated with the entirety of the image frame, where the focused mean squared error loss is the sum of a weighted mean squared error loss associated with the bounded area within the image frame and a weighted mean squared error loss associated with the entirety of the image frame.

In another aspect, the one or more controllers determine the focused perceptual loss by determining a focused perceptual loss associated with the bounded area of the image frame, and determining a focused perceptual loss associated with the entirety of the image frame, where the focused perceptual loss is the sum of a weighted perceptual loss associated with the bounded area within the image frame and a weighted perceptual loss associated with the entirety of the image frame.

In yet another aspect, the one or more controllers determine the focused total variance loss by determining a focused total variance loss associated with the bounded area of the image frame, and determining a focused total variance loss associated with the entirety of the image frame, where the focused total variance loss is the sum of a weighted focused total variance loss associated with the bounded area within the image frame and a weighted focused total variance loss associated with the entirety of the image frame.

In an aspect, the focused mean squared error loss, the focused perceptual loss, and the focused total variance loss each include different values for the bounded weighting factor and whole weighting factor.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of the disclosed super resolution system in a vehicle including one or more controllers in electronic communication with one or more cameras, according to an exemplary embodiment;

FIGS. 2A-2C illustrate examples of an object of interest that is part of obfuscated low-resolution image data, where the object of interest is obfuscated according to an obfuscation technique, according to an exemplary embodiment;

FIG. 3 is a block diagram of the software architecture of the one or more controllers shown in FIG. 1, according to an exemplary embodiment; and

FIG. 4 illustrates an exemplary image frame of the obfuscated low-resolution image data, according to an exemplary embodiment.

### DETAILED DESCRIPTION

The following description is merely exemplary in nature and is not intended to limit the present disclosure, application, or uses.

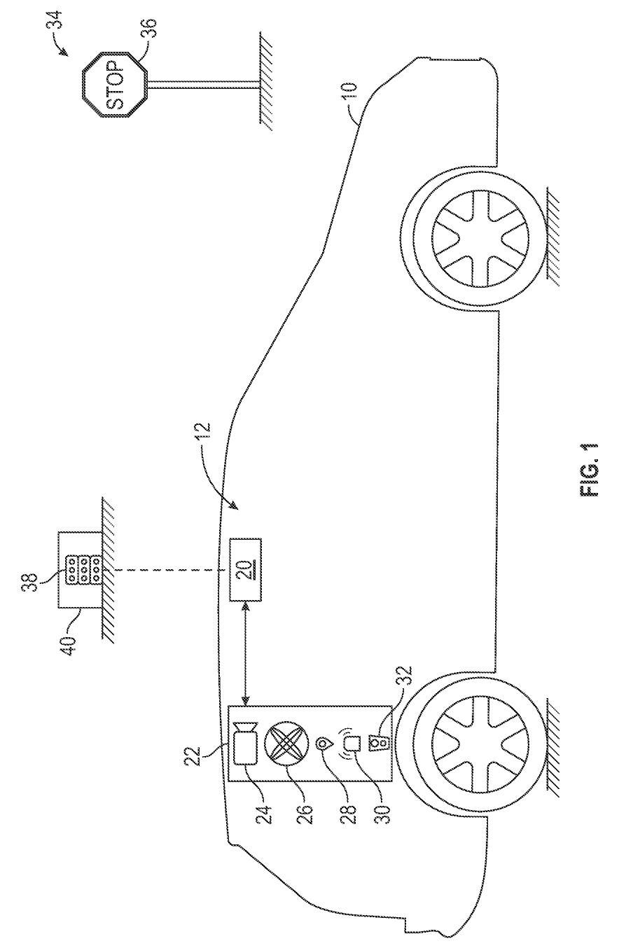

Referring to FIG. 1, an exemplary vehicle 10 including the disclosed super resolution system 12 that increases the resolution of image data captured by one or more cameras 24 is illustrated. It is to be appreciated that the vehicle 10 may be any type of vehicle such as, but not limited to, a sedan, a truck, sport utility vehicle, van, or motor home. In the embodiment as shown in FIG. 1, the super resolution system 12 includes one or more controllers 20 in electronic communication with a plurality of perception sensors 22 that collect perception data representative of a surrounding environment. In the non-limiting embodiment as shown in FIG. 1, the plurality of perception sensors 22 include one or more cameras 24 for collecting image data, an inertial measurement unit (IMU) 26, a global positioning system (GPS) 28, radar 30, and LiDAR 32, however, is to be appreciated that different or additional perception sensors may be used as well. The one or more cameras 24 are positioned to capture image data representing the surrounding environment located outside the vehicle 10.

In one embodiment, the one or more controllers 20 are in wireless communication with one or more computers 38 at a back-end office 40, where the one or more computers 38 receive the perception data collected by the one or more perception sensors 22. In one non-limiting embodiment, the one or more computers 38 are part of a crowdsourced mapping system that collects perception data from numerous connected vehicles to generate and update maps. In the embodiment as described, the super resolution system 12 is part of an object detection system for a vehicle. However, it is to be appreciated that the super resolution system 12 is not limited to object detection systems for a vehicle, and the disclosed super resolution system 12 may be used in other applications such as, for example, enhancing imaging quality in various types of media (e.g., photographs, video, and digital applications), medical imaging (e.g., magnetic resonance imaging (MRI), computed tomography (CT) scans, and microscopy), satellite imaging, restoration of archival videos and fine art, computer vision, and industrial inspection systems. Furthermore, although the super resolution system 12 is shown as part of an object detection system in the vehicle 10, the super resolution system 12 may be part of other vehicular systems as well such as, for example, automated driving systems (ADS), advanced driver assistance systems (ADAS), navigation systems, and dashcam systems.

It is to be appreciated that the image data captured by the one or more cameras 24 includes an object of interest 34 located in the surrounding environment, where the object of interest 34 is identified by the object detection system. In the embodiment as shown in FIG. 1, the object of interest 34 is a traffic sign 36, and in particular a stop sign. Although FIG. 1 illustrates the object of interest 34 as a stop sign, it is to be appreciated that the object of interest 34 may be any type of object that is identified by the object detection system system such as, but not limited to, a pedestrian, a bicyclist, an animal, a street sign, a billboard, a commercial sign, a surrounding vehicle, and an infrastructure asset. Some examples of infrastructure assets include, but are not limited to, postboxes, traffic lights such as stop lights, and traffic cones used for road construction.

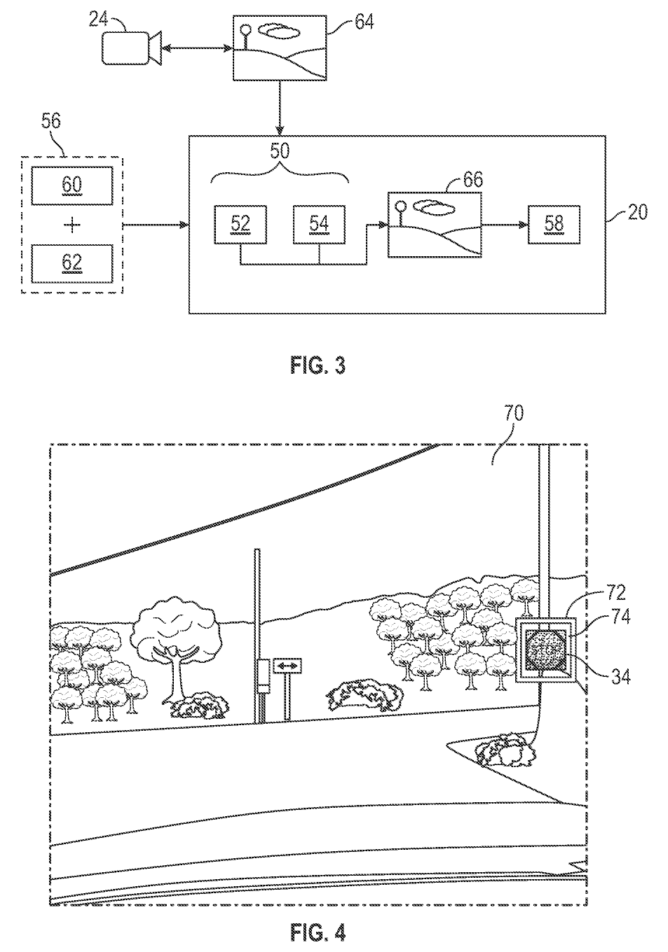

It is to be appreciated that in some instances, the object of interest 34 located in the environment surrounding the vehicle 10 may become obfuscated. For example, the object of interest 34 may be obfuscated by vegetation growth, weather conditions such as rain and fog, graffiti covering a portion or all of the object of interest 34, or by surrounding objects located in the vicinity of the object of interest 34 such as poles and surrounding vehicles. As explained below, the disclosed super resolution system 12 is trained based on paired training data 56 (FIG. 3) that includes obfuscated low-resolution image data 60 (FIG. 3). The obfuscated low-resolution image data replicates real-life occurrences when the object of interest 34 becomes obfuscated. Specifically, the obfuscated low-resolution image data obfuscates a portion of the object of interest 34 based on an obfuscation technique.

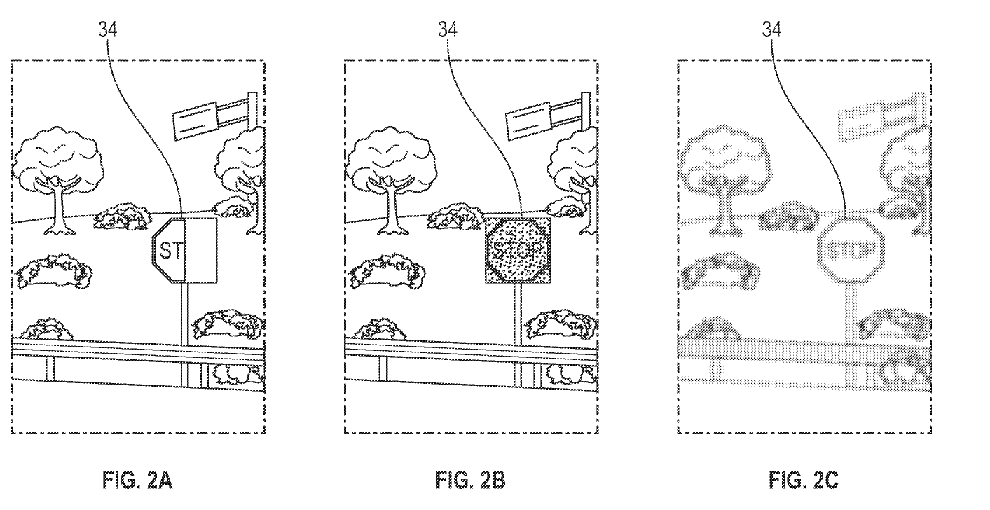

Referring to FIGS. 2A-2C, some examples of the obfuscation technique include, but are not limited to, blocking or deleting a portion of the object of interest 34 (shown in FIG. 2A), randomly removing pixels that represent the object of interest 34 (shown in FIG. 2B), blurring the object of interest 34 (shown in FIG. 2C), and darkening the image data associated with the object of interest 34 (not illustrated). Blocking or deleting a portion of the object of interest 34 reproduces real-life instances when the object of interest 34 is obfuscated by items such as, for example, other vehicles located in the surrounding environment, vegetation such as tree branches, and poles such as light poles that are often found in parking lots. Random pixel removal of the object of interest 34 reproduces real-life instances when the object of interest 34 is obfuscated by items such as, for example, vegetation such as bushes, graffiti, stickers applied to the sign, damage such as cracks or bullet holes, fog, and poles. In one embodiment, randomly removing pixels that represent the object of interest 34 may involve removing between about 25 to about 75 percent of the pixels that represent the object of interest 34. Burring the object of interest 34 reproduces real-life instances when the object of interest 34 is obfuscated by items such as, for example, inclement weather like rain or fog. Furthermore, darkening the image data may also reproduce real-life instances when the object of interest 34 is obfuscated by inclement weather.

FIG. 3 is a block diagram of the software architecture of the one or more controllers 20 shown in FIG. 1, where the one or more controllers 20 includes one or more super resolution neural networks 50 and an object detection module 58. In the embodiment as shown in FIG. 3, the one or more super resolution networks 50 include an obfuscated image data model 52 and a focused loss model 54. While FIG. 3 illustrates two super resolution neural networks 50, it is to be appreciated that in an alternative embodiment the one or more controllers 20 may include only the obfuscated image data model 52 or the focused loss model 54 instead.

The one or more controllers 20 first undergoes a training phase where the one or more controllers 20 receive the paired training data 56. The paired training data 56 is representative of the image data representing the environment surrounding the vehicle 10 including the object of interest 34 that is captured by the one or more cameras 24 and includes the obfuscated low-resolution image data 60 and high-resolution image data 62, where the obfuscated low-resolution image data 60 and the high-resolution image data 62 both represent identical images. The obfuscated low-resolution image data 60 includes a resolution that is less than or equal to 480 x 640 pixels, and the high-resolution image data 62 includes a resolution that is greater than 480 x 640 pixels. It is to be appreciated that the object of interest 34 within the obfuscated low-resolution image data 60 is obfuscated based on one of the obfuscation techniques shown in FIGS. 2A-2C to replicate real-life occurrences of when the object of interest 34 becomes obfuscated. It is to be appreciated that unlike the obfuscated low-resolution image data 60, the object of interest 34 is visible and is not obfuscated within high-resolution image data 62. Accordingly, the one or more super resolution neural networks 50 may map the obfuscated low-resolution image data 60 with the high-resolution image data 62 for purposes of reconstructing the object of interest 34 when generating a reconstructed high-resolution image. It is also to be appreciated that the object of interest 34 included in the reconstructed high-resolution image determined by the super resolution neural networks 50 is not obfuscated and is completely visible.

The obfuscated image data model 52 is any type of super resolution neural network that increases the resolution of the image data from low resolution to high resolution such as, but not limited to, a super resolution generative adversarial network (SRGAN), and a fast super resolution convolutional neural network (FSRCNN). The obfuscated image data model 52 receives the paired training data 56 as input during the training phase and increases the resolution of the obfuscated low-resolution image data 60 to create a reconstructed high-resolution image. The obfuscated image data model 52 is trained specifically to increase the resolution of the object of interest 34 (FIG. 1). That is, the obfuscated image data model 52 is specifically trained to increase the resolution of objects that are of the same type or classification as the object of interest 34. For example, when the object of interest 34 is classified as a stop sign, the obfuscated image data model 52 is specifically trained to increase the resolution of objects classified as stop signs. In addition to increasing the resolution, the obfuscated image data model 52 is specifically trained to reconstruct the object of interest 34, which is obfuscated in the obfuscated low-resolution image data 60, within the reconstructed high-resolution image. As mentioned above, the object of interest 34 included in the reconstructed high-resolution image determined by the obfuscated image data model 52 is not obfuscated and is completely visible.

The obfuscated image data model 52 calculates a total loss associated with the reconstructed high-resolution image, where the high-resolution image data 62 of the paired training data 56 acts as ground truth data. The total loss associated with the reconstructed high-resolution image is determined by calculating a mean squared error (L2) loss, a perceptual loss, an adversarial loss, and a total variance loss associated with the reconstructed high-resolution image. The total loss associated with the reconstructed high-resolution image is a sum of the mean squared error loss, a perceptual loss, an adversarial loss, and a total variance loss, or Total loss = mean squared error loss + perceptual loss + adversarial loss + total variance loss. The obfuscated image data model 52 is then trained based on an iterative process to minimize the total loss associated with the reconstructed high-resolution image.

The focused loss model 54 is any type of super resolution neural network that increases the resolution of the image data from low resolution to high resolution such as, but not limited to, such as, but not limited to, an SRGAN or a FSRCNN. The focused loss model 54 receives the paired training data 56 as input during the training phase and increases the resolution of the obfuscated low-resolution image data 60 to create a focused reconstructed high-resolution image. The focused loss model 54 is trained specifically to increase the resolution of the object of interest 34 (FIG. 1) and reconstruct the object of interest 34, which is obfuscated in the obfuscated low-resolution image data 60, within the reconstructed high-resolution image. The focused loss model 54 calculates a focused loss associated with the focused reconstructed high-resolution image, where the high-resolution image data 62 of the paired training data 56 acts as ground truth data. The focused loss model 54 is trained based on an iterative process to minimize the focused loss associated with the focused reconstructed high-resolution image.

FIG. 4 illustrates an exemplary image frame 70 of the obfuscated low-resolution image data 60. Referring to FIGS. 3 and 4, the focused loss model 54 determines a bounding box 72 defining a bounded area 74 within the image frame 70 containing the object of interest 34, which has been obfuscated based on one of the obfuscation techniques described above. The focused loss associated with the focused reconstructed high-resolution image assigns greater weight to the bounded area 74 within the bounding box 72 when compared to the entirety of the image frame 70 of the obfuscated low-resolution image data 60. Specifically, the focused loss associated with the focused reconstructed high-resolution image assigns a higher value to a bounded weighting factor corresponding to the bounded area 74 of the image frame 70 when compared to a whole weighting factor corresponding to the entirety of the image frame 70 of the obfuscated low-resolution image data 60. The focused loss model 54 determines the focused loss associated with the focused reconstructed high-resolution image by calculating a focused mean squared error loss, a focused perceptual loss, and a focused total variance loss, where the focused loss is a sum of the focused mean squared error loss, the focused perceptual loss, and the focused total variance loss.

The focused mean squared error loss is determined by determining a mean squared error loss associated with the entirety of the image frame 70, masking the bounded area 74 containing the object of interest 34 within the image frame 70 of the obfuscated low-resolution image data 60, and determining a mean squared error loss associated with the bounded area 74 of the image frame 70. The focused mean squared error loss is the sum of a weighted mean squared error loss associated with the bounded area 74 within the image frame 70 and a weighted mean squared error associated with the entirety of the image frame 70.

The weighted mean squared error loss associated with the bounded area 74 within the image frame 70 is determined by multiplying the mean squared error loss associated with the bounded area 74 within the image frame 70 with the bounded weighting factor, or (A*mean squared error loss associated with the bounded area 74 within the image frame 70), where A represents the bounded weighting factor. The weighted mean squared error loss associated with the entirety of the image frame 70 is determined by multiplying the mean squared error loss associated with the entirety of the image frame 70 with the whole weighting factor, or (B*mean squared error loss associated with the entirety of the image frame 70), where B represents the whole weighting factor.

It is to be appreciated that the bounded weighting factor A is greater than the whole weighting factor B, or A<B, and the sum of the bounded weighting factor A and the whole weighting factor B is equal to one, or A + B = 1. Merely by way of example, in one embodiment the bounded weighting factor A is equal to 0.8 and the whole weighting factor is equal to 0.2. Therefore, more weight is given to the bounded area 74 within the image frame 70 containing the object of interest 34 when compared to the entire image frame 70, which improves the ability of the focused loss model 54 to reconstruct the object of interest 34 within the focused reconstructed high-resolution image.

The focused perceptual loss is determined by determining a perceptual loss associated with the entirety of the image frame 70, masking the bounded area 74 of the image frame 70 of the obfuscated low-resolution image data 60, and determining a perceptual loss associated with the bounded area 74 of the image frame 70. The focused perceptual loss is the sum of a weighted perceptual loss associated with the bounded area 74 within the image frame 70 and a weighted perceptual loss associated with the entirety of the image frame 70.

The weighted perceptual loss associated with the bounded area 74 within the image frame 70 is determined by multiplying the perceptual loss associated with the bounded area 74 within the image frame 70 with the bounded weighting factor, or (A*perceptual loss associated with the bounded area 74 within the image frame 70). The weighted perceptual loss associated with the entirety of the image frame 70 is determined by multiplying the perceptual loss associated with the entirety of the image frame 70 with the whole weighting factor, or (B*perceptual loss associated with the entirety of the image frame 70). In embodiments, the bounded weighting factor used for determining the weighted perceptual loss may be a different value than the bounded weighting factor used for determining the weighted mean squared error loss. Similarly, the whole weighting factor used for determining the weighted perceptual loss may be a different value than the whole weighting factor used for determining the weighted mean squared error loss. Accordingly, the focused mean squared error loss, the focused perceptual loss, and the focused total variance loss may be prioritized by assigning each different type of loss different values for the bounded weighting factor and whole weighting factor.

The focused total variance loss is determined by determining a total variance loss associated with the entirety of the image frame 70, masking the bounded area 74 of the image frame 70 of the obfuscated low-resolution image data 60, and determining a total variance loss associated with the bounded area 74 of the image frame 70. The focused total variance loss is the sum of a weighted total variance loss associated with the bounded area 74 within the image frame 70 and a weighted total variance loss associated with the entirety of the image frame 70.

The weighted total variance loss associated with the bounded area 74 within the image frame 70 is determined by multiplying the total variance loss associated with the bounded area 74 within the image frame 70 with the bounded weighting factor, or (A*total variance loss associated with the bounded area 74 within the image frame 70). The weighted total variance loss associated with the entirety of the image frame 70 is determined by multiplying the total variance loss associated with the entirety of the image frame 70 with the whole weighting factor, or (B*total variance loss associated with the entirety of the image frame 70). In embodiments, the bounded weighting factor used for determining the weighted total variance loss may be a different value than the bounded weighting factor used for determining the weighted mean squared error loss and the weighted perceptual loss. Similarly, the whole weighting factor used for determining the weighted total variance loss may be a different value than the whole weighting factor used for determining the weighted mean squared error loss and the weighted perceptual loss. Accordingly, the focused mean squared error loss, the focused perceptual loss, and the focused total variance loss may be prioritized by assigning each different type of loss different values for the bounded weighting factor and whole weighting factor.

Referring to FIG. 3, once the one or more super resolution neural networks 50 are trained, the one or more controllers 20 may then undergo a testing phase. During the testing phase, the one or more controllers 20 receive real-life low-resolution image data 64 representing the surrounding environment including the object of interest 34 that is captured by the one or more cameras 24. During the testing phase, the obfuscated image data model 52, the focused loss model 54, or both the obfuscated image data model 52 and the focused loss model 54 receive the real-life low-resolution image data 64 as input during the testing phase and increases the resolution of the real-life low-resolution image data 64 to create a real-life high-resolution image data 66.

The object detection module 58 receives the real-life high-resolution image data 66 as input and executes one or more object detection algorithms to determine an instance of the object of interest 34 within the real-life high-resolution image data 66. It is to be appreciated that the object detection module 58 may execute any type of object detection algorithm such as, but not limited to, the you-only-look-once (YOLO) algorithm. It is to be appreciated that the real-life high-resolution image data 66 determined by the obfuscated image data model 52 and the focused loss model 54 results in improved object detection accuracy of the object of interest 34 when compared to high-resolution images determined by a standard image data model that is not trained based on obfuscated low-resolution image data that obfuscates the object of interest 34. In one non-limiting example, the real-life high-resolution image data 66 determined by the obfuscated image data model 52 results in an object detection accuracy of the object of interest 34 of about 59%, and the real-life high-resolution image data 66 determined by the focused loss model 54 results in an object detection accuracy of of the object of interest 34 of about 64%. In contrast, a standard image data model that is not trained based on obfuscated low-resolution image data may result in an object detection accuracy of only about 40%. In the present example, all testing data was obtained based on the same dataset of 1225 images of stop signs.

Referring generally to the figures, the disclosed super resolution system provides various technical effects and benefits. The super resolution system employs a customized approach to train super resolution neural networks based on low-resolution image data that obfuscates the object of interest, where the super resolution neural networks are specifically trained increase the resolution of the object of interest. The obfuscated objects within the low-resolution image data replicate real-life occurrences when the object of interest in the surrounding environment becomes obfuscated. Therefore, the super resolution system improves the detectability of objects in low-resolution images as well as in images containing obfuscated objects. Furthermore, the disclosed super resolution system also maximizes the capability of cameras that acquire lower resolution image data.

The controllers may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the controllers may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A super resolution system that increases a resolution of image data captured by one or more cameras, the super resolution system comprising:
one or more controllers including one or more super resolution neural networks that include an obfuscated image data model, wherein the one or more controllers include one or more processors that execute instructions to:
receive, by the obfuscated image data model, paired training data during a training phase, wherein the paired training data is representative of the image data captured by the one or more cameras representing a surrounding environment and includes obfuscated low-resolution image data and high-resolution image data, and wherein the obfuscated low-resolution image data and the high-resolution image data both represent identical images, and the obfuscated low-resolution image data includes an object of interest located in the surrounding environment that is obfuscated based on an obfuscation technique;
increase, by the obfuscated image data model, a resolution of the obfuscated low-resolution image data to create a reconstructed high-resolution image;
calculate, by the obfuscated image data model, a total loss associated with the reconstructed high-resolution image, wherein the high-resolution image data of the paired training data acts as ground truth data and the obfuscated image data model is trained based on an iterative process to minimize the total loss;
receive, by the obfuscated image data model, real-life low-resolution image data a testing phase; and
increase, by the obfuscated image data model, the resolution of the real-life low-resolution image data to create real-life high-resolution image data.

2. The super resolution system of claim 1, wherein the total loss associated with the reconstructed high-resolution image is a sum of a mean squared error loss, a perceptual loss, an adversarial loss, and a total variance loss.

3. The super resolution system of claim 1, wherein the one or more super resolution neural networks includes a focused loss model.

4. The super resolution system of claim 3, wherein the one or more controllers execute instructions to:
receive, by the focused loss model, the paired training data during the training phase;
increase, by the focused loss model, a resolution of the obfuscated low-resolution image data to create a focused reconstructed high-resolution image;
calculate, by the focused loss model, a focused loss associated with the focused reconstructed high-resolution image, wherein the high-resolution image data of the paired training data acts as ground truth data and the focused loss is a sum of a focused mean squared error loss, a focused perceptual loss, and a focused total variance loss;
receive, by the focused loss model, real-life low-resolution image data a testing phase; and
increase, by the focused loss model, the resolution of the real-life low-resolution image data to create real-life high-resolution image data.

5. The super resolution system of claim 4, wherein the one or more controllers execute instructions to:
determine a bounding box defining a bounded area within an image frame of the obfuscated low-resolution image data, wherein the bounding box contains the object of interest.

6. The super resolution system of claim 5, wherein the focused loss associated with the focused reconstructed high-resolution image assigns a higher value to a bounded weighting factor corresponding to the bounded area of the image frame when compared to a whole weighting factor corresponding to the entirety of the image frame.

7. The super resolution system of claim 6, wherein the one or more controllers determine the focused mean squared error loss by:
determining a mean squared error loss associated with the bounded area of the image frame; and
determining a mean squared error loss associated with the entirety of the image frame, wherein the focused mean squared error loss is the sum of a weighted mean squared error loss associated with the bounded area within the image frame and a weighted mean squared error loss associated with the entirety of the image frame.

8. The super resolution system of claim 6, wherein the one or more controllers determine the focused perceptual loss by:
determining a focused perceptual loss associated with the bounded area of the image frame; and
determining a focused perceptual loss associated with the entirety of the image frame, wherein the focused perceptual loss is the sum of a weighted perceptual loss associated with the bounded area within the image frame and a weighted perceptual loss associated with the entirety of the image frame.

9. The super resolution system of claim 6, wherein the one or more controllers determine the focused total variance loss by:
determining a focused total variance loss associated with the bounded area of the image frame; and
determining a focused total variance loss associated with the entirety of the image frame, wherein the focused total variance loss is the sum of a weighted focused total variance loss associated with the bounded area within the image frame and a weighted focused total variance loss associated with the entirety of the image frame.

10. The super resolution system of claim 6, wherein the focused mean squared error loss, the focused perceptual loss, and the focused total variance loss each include different values for the bounded weighting factor and whole weighting factor.

11. The super resolution system of claim 1, wherein the object of interest is one of the following: a traffic sign, a pedestrian, a bicyclist, an animal, a street sign, a billboard, a commercial sign, a surrounding vehicle, and an infrastructure asset.

12. The super resolution system of claim 1, wherein the obfuscated low-resolution image data includes a resolution that is less than or equal to 480 x 640 pixels, and the high-resolution image data includes a resolution that is greater than 480 x 640 pixels.

13. The super resolution system of claim 1, wherein the obfuscation technique includes one of the following: deleting a portion of object of interest, randomly removing pixels that represent the object of interest, blurring the object of interest, and darkening image data associated with the object of interest.

14. A super resolution system that increases a resolution of image data captured by one or more cameras, the super resolution system comprising:
one or more controllers including one or more super resolution neural networks that include a focused loss model, wherein the one or more controllers include one or more processors that execute instructions to:
receive, by the focused loss model, paired training data during a training phase, wherein the paired training data is representative of the image data captured by the one or more cameras representing a surrounding environment and includes obfuscated low-resolution image data and high-resolution image data, and wherein the obfuscated low-resolution image data and the high-resolution image data both represent identical images, and the obfuscated low-resolution image data includes an object of interest located in the surrounding environment that is obfuscated based on an obfuscation technique;
increase, by the focused loss model, a resolution of the obfuscated low-resolution image data to create a focused reconstructed high-resolution image;
calculate, by the focused loss model, a focused loss associated with the focused reconstructed high-resolution image, wherein the high-resolution image data of the paired training data acts as ground truth data and the focused loss is a sum of a focused mean squared error loss, a focused perceptual loss, and a focused total variance loss;
receive, by the obfuscated image data model, real-life low-resolution image data a testing phase; and
increase, by the obfuscated image data model, the resolution of the real-life low-resolution image data to create real-life high-resolution image data.

15. The super resolution system of claim 14, wherein the one or more controllers execute instructions to:
determine a bounding box defining a bounded area within an image frame of the obfuscated low-resolution image data, wherein the bounding box contains the object of interest.

16. The super resolution system of claim 15, wherein the focused loss associated with the focused reconstructed high-resolution image assigns a higher value to a bounded weighting factor corresponding to the bounded area of the image frame when compared to a whole weighting factor corresponding to the entirety of the image frame.

17. The super resolution system of claim 16, wherein the one or more controllers determine the focused mean squared error loss by:
determining a mean squared error loss associated with the bounded area of the image frame; and
determining a mean squared error loss associated with the entirety of the image frame, wherein the focused mean squared error loss is the sum of a weighted mean squared error loss associated with the bounded area within the image frame and a weighted mean squared error loss associated with the entirety of the image frame.

18. The super resolution system of claim 16, wherein the one or more controllers determine the focused perceptual loss by:
determining a focused perceptual loss associated with the bounded area of the image frame; and
determining a focused perceptual loss associated with the entirety of the image frame, wherein the focused perceptual loss is the sum of a weighted perceptual loss associated with the bounded area within the image frame and a weighted perceptual loss associated with the entirety of the image frame.

19. The super resolution system of claim 16, wherein the one or more controllers determine the focused total variance loss by:
determining a focused total variance loss associated with the bounded area of the image frame; and
determining a focused total variance loss associated with the entirety of the image frame, wherein the focused total variance loss is the sum of a weighted focused total variance loss associated with the bounded area within the image frame and a weighted focused total variance loss associated with the entirety of the image frame.

20. The super resolution system of claim 16, wherein the focused mean squared error loss, the focused perceptual loss, and the focused total variance loss each include different values for the bounded weighting factor and whole weighting factor.
